(19) United States
(12) Patent Application Publication
(10) Pub. No.: US 2009/0165477 A1
(43) Pub. Date: Jul. 2, 2009

(54) FILL LEVEL MEASURING DEVICE AND METHOD FOR MEASURING THE FILL LEVEL OF LIQUID FOOD IN A CONTAINER

(75) Inventors: Holger Sturken, Erlen (CH); Hans-Peter Hoch, Brittnau (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: NIRO-PLAN AG, Aarburg (CH)

(21) Appl. No.: 12/325,446

(22) Filed: Dec. 1, 2008

(30) Foreign Application Priority Data
Nov. 30, 2007 (DE) 102007057832.8

(51) Int. Cl. F25B 49/00; G01F 23/00

(52) U.S. Cl. 62/129; 702/55; 73/290 R

(57) ABSTRACT

A fill level measuring device for measuring the fill level of liquid food in a container is provided which includes a sensor unit and a processing unit. The processing unit being is connected to the sensor unit and embodied such that the processing unit determines the fill level of the liquid food in the container depending on the measuring signals of the sensor unit, with the sensor unit comprising a container pressure sensor. The container pressure sensor is effectively connected with the liquid food in the container in order to measure the fluid pressure of the liquid food in the container and the processing unit is embodied such that it determines the fill level of the liquid food in the container depending on a difference of the fluid pressure measured in reference to the environmental pressure.

### CROSS-REFERENCE TO RELATED APPLICATIONS

This application claims the benefit of DE 10 2007 057 832.8, filed Nov. 30, 2007, which is incorporated herein by reference as if fully set forth.

### BACKGROUND

The invention relates to a fill level measuring device for measuring the fill level of liquid food as well as a method for measuring the fill level of liquid foods in a container.

Containers for liquid food are used in a multitude of devices for the production or dispensation of liquid food.

Typically, in these devices a liquid food is taken from the vessel via a supply line using a pump. Simultaneously, via a fill level measuring device, the fill level of the container is monitored so that preset actions can be executed when the container is empty or at least when the contents fall below a certain low fill level, such as triggering a respective signal for the operator or canceling the pumping process.

Typical fields of application for such fill level measuring devices are coffee makers, in which in addition to the coffee produced by a brewing unit also other liquid food is to be dispensed into a cup, such as milk and/or syrup. Such coffee makers are typically provided with a refrigeration device, in which a milk container is stored, for example. Milk is pumped out of the milk container as needed, with the pumping process being interrupted when the container is empty so that the pump cannot “run dry”, i.e. pump without any liquid.

Here, it is known to monitor the fill level of the container via a fill level measuring device using capacitive resistance. The capacitor is arranged near or at the container. When no or only little liquid food is located in the container, the capacitive resistance value changes, thus allowing detection of the fill level.

In such devices it is problematic that the functionality of the fill monitoring depends on the arrangement between the capacitor and the container and that furthermore the measuring is imprecise so that frequently an empty vessel is detected in spite of the fact that still considerable remnants of liquid foods are located in the container. Furthermore, the control and monitoring of the capacitive resistor sets high requirements for the control system so that a precise calibration is necessary and faulty adjustments can occur, which lead to further falsifications of the measuring result and thus the detection process.

It is also known to determine the fill level of the container such that the weight of the container is measured. Here, too, the precise detection of the fill level is problematic, because for a precise detection the exact net weight of the container must be known. Thus, imprecision develops during measurements leading to detection of a container as being empty which actually is not entirely empty and consequently it is exchanged although still quite a considerable amount of the liquid food remains contained therein.

### SUMMARY

The invention is based on the object of improving the fill level measuring devices of prior art for measuring the fill level of liquid food in a container such that a more cost-effective and simultaneously a more precise monitoring of the fill level of the container for liquid food is possible.

This object is attained in a fill level measuring device according to the invention as well as a method for measuring the fill level according to the invention.

Advantageous embodiment of the device and the method are provided in the description and claims below.

The fill level measuring device according to the invention for measuring the fill level of liquid food in a container therefore comprises a sensor unit and a processing unit, with the processing unit being connected to the sensor unit. The processing unit determines the fill level of the liquid food in the container dependent on the measuring signals of the sensor unit.

It is essential for the sensor unit to comprise a container pressure sensor. This container pressure sensor can be brought into an effective connection with the liquid food in the container so that the pressure of the liquid food in the container can be measured via the container pressure sensor. Furthermore, the processing unit is embodied such that it determines the fill level of the liquid food in the container depending on the difference of the measured fluid pressure of the liquid in reference to an environmental pressure.

Therefore, contrary to prior art, in the fill level measuring device according to the invention the fluid pressure of the liquid food in the container is measured. The invention uses the fact that the pressure of the liquid food is always higher than the environmental pressure. Depending on the pressure difference between the fluid pressure and the environmental pressure it can therefore be detected whether or not any liquid is located in the container.

If the pressure measured is higher than the environmental pressure liquid food is still located at the measuring point of the pressure sensor of the container.

Thus, in this measuring method proven components, such as container pressure sensors, can be used and the disadvantages of measuring by capacitors can be avoided.

Advantageously the fluid pressure is measured in the area of the bottom of the container so that only in an empty or almost empty container the pressure at the container pressure sensor is equivalent to the environmental pressure so that no or only a negligibly small residual amount of liquid food is left in the container when the container is detected as being empty.

It is particularly beneficial to measure the fluid pressure at a height of less than 5 cm above the bottom of the container, most particularly at a maximum height of less than 1 cm above the bottom of the container.

As already described the fill level measuring device according to the invention operates based on the fact that the fluid pressure is always higher than the environmental pressure. Here, the environmental pressure in the fill level measuring device can be preset by the manufacturer. Typically a standard environmental pressure of 1 bar (1,000 kg/m²) is preset. Due to the fact that the environmental pressure can change, though, particularly depending on the elevation above sea level of the place of operation of the fill level measuring device according to the invention, the processing unit of the fill level measuring device according to the invention preferably comprises an input unit, by which its environmental pressure can be preset. In this way, the operator can enter the actually existing environmental pressure at the place of operation so that a correct determination of the pressure difference between the fluid pressure and the environmental pressure occurs.

However, in order to simplify the handling of the measuring device according to the invention it is beneficial for it to additionally comprise a sensor for the environmental pressure. The environmental pressure sensor is arranged such that the pressure of the environment of the container can be measured via the environmental pressure sensor. The processing unit is connected to the environmental pressure sensor and determines the environmental pressure from the measurement data of the environmental pressure sensor.

In this way, the difference between the fluid pressure and the environmental pressure can be formed fully automatically without requiring any input from the operator. In particular, in this preferred embodiment any falsification during the determination of the pressure difference is excluded, for example based on a change of environmental pressure by changing weather conditions.

As described above, using the fill level measuring device according to the invention it can be determined if any liquid is or is not present at the location in the container where the container pressure sensor measures the fluid pressure. Therefore, first the detection of an empty or almost empty container is possible via the fill level measuring device according to the invention.

Furthermore, using the fill level measuring device according to the invention, the height of the fill level of the liquid food in the container above the measuring location at which the fluid pressure is measured can also be determined.

The pressure of a liquid in a container at a certain measuring location is independent from the shape of the container, only dependent on the environmental pressure and the height of the fill level of the liquid above the measuring location where the fluid pressure is measured.

By determining the pressure difference between the environmental pressure and the fluid pressure, it can therefore not only determine if any liquid is still present in the container but furthermore the height of the fill level can also be determined. This way, for example, the display of a percentage of the fill level is possible. When the shape of the container is known it is also possible to deduct the remaining amount of the liquid food from the height of the fill level and to display it to the user.

In particular the determination of the fill level requires a precise determination of the pressure difference between the fluid pressure and the environmental pressure so that particularly in this advantageous embodiment, an additional environmental pressure sensor as described above is beneficial in order to avoid measuring errors during the determination of the pressure difference.

In another advantageous embodiment, the pressure sensor of the container is embodied in a watertight manner and connected to the processing unit via an electric line to transfer the measuring signals. In this way, the pressure sensor of the container can be inserted into the container so that it preferably is arranged near the bottom of the container. By this arrangement, as described above, the fill level of the liquid food in the container is determined.

When the height is known, at which the fluid pressure is measured in reference to the bottom of the container, this height is additionally added to the fill level determined from the pressure difference so that a precise fill level of the liquid food in the container is yielded.

In another advantageous embodiment, the measuring device comprises at least one pressure connector which is effectively connected to the pressure sensor of the container. The pressure connector is introduced, on the one hand, when the fill level measuring device according to the invention is used in the container with the liquid foods such that one end of the pressure connector is arranged near the bottom of the container. Another end of the pressure connector is connected to the pressure sensor of the container such that by the pressure connector, the pressure sensor of the container determines the fluid pressure in the area of the bottom of the container.

Particularly, the embodiment of the pressure connector in the form of a flexible hose is advantageous. The flexible hose is connected at one end with a pressure sensor of the container and closed thereby. The other end of the flexible hose is open and is introduced into the container with the liquid food such that the open end of the flexible hose is located in the bottom area of the container. The air in the flexible hose is slightly compressed by the fluid pressure so that a small amount of the liquid food enters the flexible hose. Similarly the fluid pressure is transferred via the air located in the above-mentioned flexible hose to the pressure sensor of the container and measured thereby.

Due to the fact that only a small amount of the liquid food enters the flexible hose the maintenance and/or cleaning expense due to liquid entering is negligibly small. It is also possible to close the open end of the flexible hose with a flexible but liquid-impermeable membrane so that no liquid food can enter the inside of the flexible hose via said membrane.

For a simple handling of the fill level device according to the invention, the pressure connector advantageously comprises a closure for the container for liquid food. The pressure connector is here fastened to the closure such that when the closure is placed onto the container, the end of the pressure connector extending into the container ends in the area at the bottom of the container, particularly at a distance of less than 5 cm, most particularly at a distance of less than 1 cm from the bottom of the container.

It is particularly advantageous for the pressure connector to be embodied in a stiff manner, for example as a pipe, and cut diagonally at the end that is inserted into the container. Here, the pressure connector can be sized such that it rests on the bottom of the container when the closure is placed on the container. The diagonally cut end of the pressure connector ensures that the pressure connector cannot be closed by the bottom of the container, but that in the immediate proximity of the bottom, liquid can enter the pressure connector from the container through the diagonally cut end of the pressure connector.

This achieves in a simple fashion that, when the container is closed by the operator, automatically a precise positioning of the measuring point for the fluid pressure in the area of the bottom of the container is ensured and functional errors are avoided.

For this purpose, the pressure connector is advantageously provided with a stiff part and a flexible one, with the part of the pressure connector, projecting into the container when the closure is placed onto the container, being embodied stiff and the remaining part of the pressure connector being embodied flexible at least in part. In this way, a simple handling by the user is possible, because the flexible part allows mobility of the closure in reference to the pressure sensor of the container and the stiff part ensures that a correct arrangement of the pressure connector occurs inside the container.

Advantageously the fill level measuring device is additionally provided with a conveyor line. This conveyor line is at least partially arranged at the part of the pressure connector projecting into the container. This way, the conveyor line and the pressure connector can easily be inserted into the container simultaneously, so that the conditions for pumping liquid food from the container and for measuring the fill level are ensured.

Advantageously the conveyor line is embodied equivalent to the pressure connector, i.e. it has an essentially stiff part which projects into the container when the closure is placed on and a flexible part outside the closure allowing the mobility of the closure when the container is exchanged.

In another advantageous embodiment, the fill level measuring device comprises a conveyor line for the liquid food and a temperature sensor. The temperature sensor is thermally connected to the conveyor line so that the temperature of a liquid flowing in the conveyor line can be measured via the temperature sensor.

In this way, both the temperature of the liquid food transported from the container can be measured by the temperature sensor without the temperature sensor having to be arranged in the container with the liquid food.

This facilitates the handling of the fill level measuring device according to the invention when exchanging the container, because it is not necessary to remove an additional temperature sensor from the empty container and place it into the new full container.

A typical application of the fill level measuring device according to the invention is a refrigerating device for liquid foods, preferably coffee makers. In particular in coffee makers it is common to provide a refrigeration device with an insulating vessel to accept a container for liquid food, with the insulating vessel being cooled via the refrigerating assembly. For example, a container with milk can be inserted into the insulating vessel, with the cooling of the milk via the refrigerating assembly preventing early spoilage. The refrigeration device comprises a fill level measuring device according to the invention so that the fill level of the liquid food in the container inserted into the insulating vessel is measured by the fill level measuring device.

In a preferred embodiment, the fill level measuring device is arranged in the insulating vessel such that only electric lines must be guided from the processing unit to transfer the measuring results to the outside and the insulating effect of the insulating vessel is therefore not restricted.

Here, it is particularly advantageous for the insulating vessel to be divided into two chambers by a separating wall, with the first chamber being embodied to accept the container for liquid food and with the processing unit of the fill level measuring device being arranged in the second chamber. The separating wall prevents liquid food perhaps present during the exchange of containers from entering the processing unit and damaging it.

### BRIEF DESCRIPTION OF THE DRAWINGS

In the following, additional advantageous embodiments are explained using the exemplary embodiments shown in the figures. Shown are:

FIG. 1 is a schematic view of a fill level measuring device according to the invention,

FIG. 2 is a view of a refrigeration device with a fill level measuring device and a container for liquid foods inserted therein, in which the processing unit of the fill level measuring device is arranged outside the insulating vessel of the refrigerating unit, and

FIG. 3 is a view of a refrigeration device with a fill level measuring device according to the invention in which the insulating vessel is divided into two chambers by a separating wall.

### DETAILED DESCRIPTION OF THE PREFERRED EMBODIMENTS

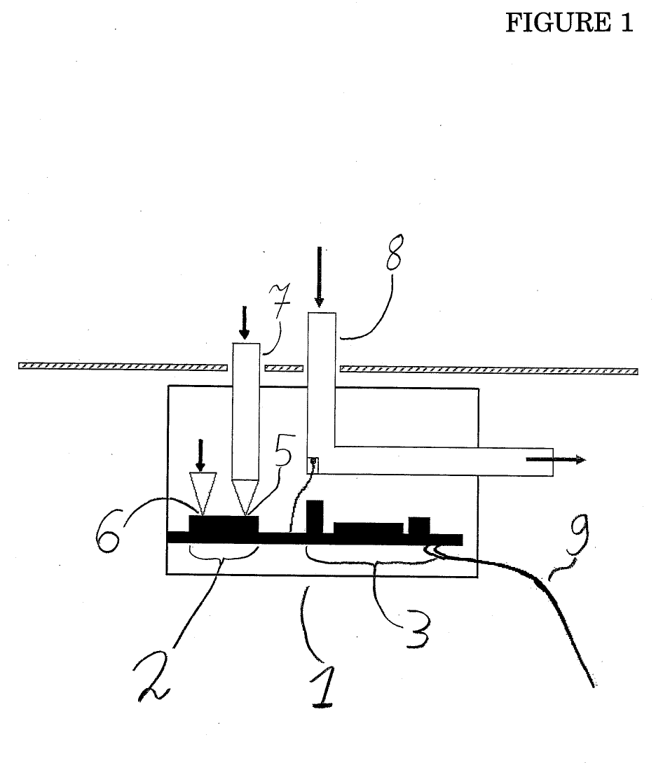

FIG. 1 shows a fill level measuring device 1 according to the invention, comprising a sensor unit 2, a processing unit 3, and a temperature sensor 4. The sensor unit 2 comprises a container pressure sensor 5 and an environmental pressure sensor 6.

The fill level measuring device further comprises a pressure connection 7, which is effectively connected to the container pressure sensor 5. Furthermore, the fill level measuring device comprises a conveyor line 8, with a temperature sensor 4 being arranged thereat, so that the temperature of the liquid flowing through the conveyor line 8 can be measured by the temperature sensor.

On the one hand the fill level measuring device according to the invention can be supplied with energy via an electrical connector 9 and, on the other hand, the measurements are displayed via the electrical connector 9.

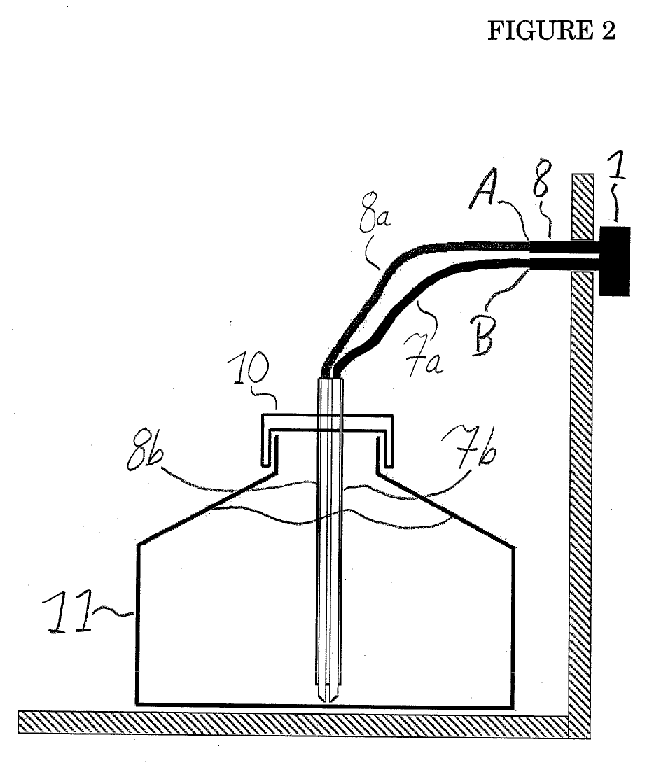

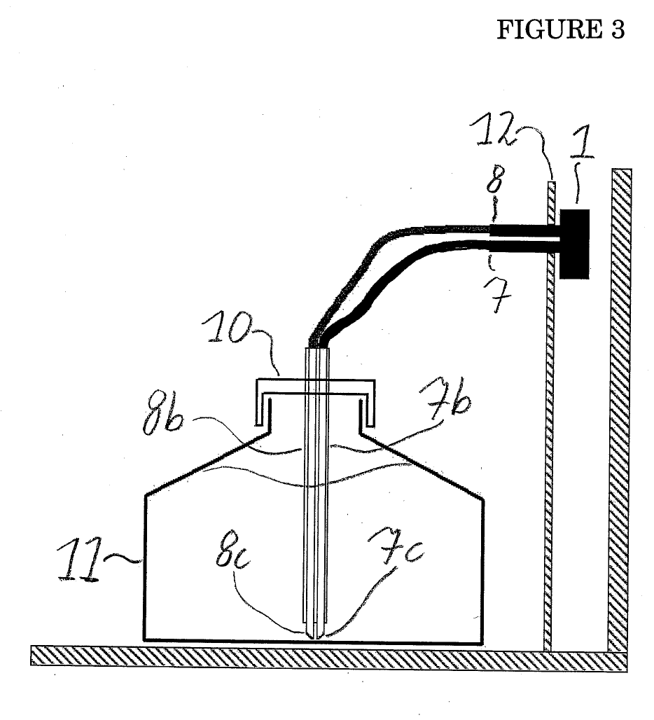

The pressure connector 7 is embodied in a tubular fashion, with one end being closed by the container pressure sensor 5. The other end (see FIGS. 2 and 3) is arranged in the area of the bottom of a container for liquid food so that the fluid pressure in the area of the bottom of the container can be measured by the container pressure sensor 5.

Using an environmental pressure sensor 6, the environmental pressure of the fill level measuring device and thus the environmental pressure of the container and the liquid food located inside the container are measured.

The processing unit 3 determines the pressure difference between the fluid pressure in the bottom of the container and the environmental pressure from the measuring signals of the container pressure sensor 5 and the environmental pressure sensor 6.

The fill level is determined therefrom according to the following formula 1

$$h = \frac{dp}{ρ \cdot g} \qquad ( formula 1 )$$

with the fill level h [m], the pressure difference dp [N/m²], the specific gravity ρ [kp/m³], and the acceleration of the earth's gravity g [m/s²].

Due to the fact that typically used liquid food has a specific gravity similar to water and the gravitational acceleration of the earth varies only slightly at different locations on earth the value ρ=1,000 kg/m³ and the value g=9.81 m/s² are predetermined for the processing unit 3.

Furthermore, these values can be changed though by the operator via the electrical connector 9 using a control unit (not shown), in order to adjust them to the precise values for the operating location of the fill level measuring device.

The processing unit 3 determines, according to the above-shown formula 1, the fill level depending on the determined difference between the fluid pressure and the environmental pressure and displays it via the electric connection 9 on a display unit (not shown.)

In empty containers, i.e. when the fill level is 0 or nearly 0, additionally a warning signal is triggered via the electric connector 9, so that the operator is made aware of the empty or nearly empty container.

Furthermore, a blocking signal is issued via the electrical connector 9. The electric connector 9 is connected to a control unit of a drink dispensing device, which is supplied with liquid food from the container 11. The dispensation of liquid food is interrupted by the blocking signal such that no drink can be requested when the container is empty or nearly empty, so that first the container 11 must be exchanged.

Additionally, the temperature of the liquid food flowing through the conveyor line 8 is determined by the processing unit 3 using the temperature sensor 4 and is also displayed via the electrical connector 9.

FIG. 2 shows the use of the fill level measuring device according to the invention in a refrigeration device, with only the right wall and the bottom of an insulating vessel of the refrigerating device being indicated in shaded lines. The fill level measuring device 1 is mounted outside the insulating vessel of the refrigeration device, with the conveyor line 8 and the pressure connector 7 penetrating the side wall of the insulating vessel.

As discernible from FIG. 2, the fill level measuring device additionally comprises a closure 10. During use, the closure 10 is placed onto the container 11 for liquid food located inside the insulating vessel. The pressure connector 7 and the conveyor line 8 are each provided with a flexible part 7a and 8a, as well as an essentially stiff part 7b and 8b, mounted to the closure 10 such that, when the closure 10 is placed onto the container 11, the bottom ends of the pressure connector 7 and the conveyor line 8 are arranged at a distance from the bottom of the container 11 of approximately 0.5 cm.

Due to the flexible areas 7a and 8a the closure 10 can easily be removed from the container and the stiff areas 7b and 8b ensure the correct positioning of the lower ends of the pressure connector 7 and the conveyor line 8 in the container 11 during use.

The closure 10 is further provided with a small opening (diameter smaller than 0.5 cm) (not shown) so that when liquid food is dispensed air can enter the container 11 and thus a vacuum is always given in the area of the container not filled with liquid food.

FIG. 3 shows another exemplary embodiment, in which the refrigeration device is additionally provided with a separating wall 12, which divides the insulating vessel of the refrigeration device into two chambers. In this exemplary embodiment, the fill level measuring device is arranged in the insulating vessel, namely in the chamber separated by the dividing wall 12 located on the right in FIG. 3.

The separating wall 12 is penetrated by the pressure connector 7 and the conveyor line 8, so that they can be connected to a container 11, connected to the chamber shown left in FIG. 3, as already described in FIG. 2.

In the exemplary embodiment shown in FIG. 3, the electrical connector 9 (not shown) must therefore only penetrate the insulating wall of the insulating vessel of the refrigeration device. Furthermore, the fill level measuring device 1 is protected by the separating wall 12 from contamination, for example, by leakage of liquid foods due to improper operation when the container 11 is exchanged.

Furthermore, pressure connectors and conveyor lines are detachably connected to the points marked A and B in FIG. 2, so that for maintenance purposes and for hygienic reasons the partial sections 8a and 8b of the conveyor line as well as 7a and 7b of the pressure connector can be exchanged in a simple way without requiring to remove the processing unit and the pressure sensors.

As discernible from FIGS. 2 and 3, the stiff areas 7b and 8b of the pressure connector 7 and the conveyor line 8 are cut diagonally at their ends (see markings 7c and 8c in FIG. 3.) In this way, the length of the sections 7b and 8b can be sized such that when the closure 10 is placed onto the container 11, the ends 7c and 8c extend to the bottom of the container 11 or rest thereupon. By the diagonal cut of the stiff sections 7b and 8b it is always ensured that the pressure connector 7 and the conveyor line 8 are not closed by the bottom of the container 11, but that liquids from the container 11 can enter laterally into the pressure connector 7 and the conveyor line 8.

Of course, it is also possible instead of the diagonal cut, to select other embodiments for the end of the pressure connector 7 and the supply line 8, which also allow a support on the bottom without allowing closing the conveyor line and/or the pressure connector by the bottom. For example, the ends can be embodied as cages or other lateral openings in the end sections, which allow liquids to laterally enter into the pressure connector and/or the conveyor line.

1. A fill level measuring device (1) for measuring a fill level of liquid food in a container (11), comprising a sensor unit (12) and a processing unit (3), with the processing unit (3) being connected to the sensor unit (2) and embodied such that the processing unit (3) determines the fill level of the liquid food in the container (11) depending on measuring signals from the sensor unit (2), the sensor unit (2) comprises a container pressure sensor (5) that can be brought into an effective connection with the liquid food in the container (11) to measure a fluid pressure of the liquid food in the container (11) and the processing unit (3) is embodied such that it determines the fill level of the liquid food in the container (11) depending on a difference of a measured fluid pressure in reference to environmental pressure.

2. A fill level measuring device (1) according to claim 1, wherein the fill level measuring device (1) is embodied such that the fluid pressure can be measured in an area of a bottom of the container (11) at a height of less than 5 cm above the bottom of the container.

3. A fill level measuring device (1) according to claim 1, wherein the processing unit (3) comprises an input unit and is embodied such that the environmental pressure can be preset via the input unit.

4. A fill level measuring device (1) according to claim 1, wherein the sensor unit (2) additionally comprises an environmental pressure sensor (6) that is arranged such that the environmental pressure can be measured for the environment of the container (11) and the processing unit (3) is embodied such that it determines the environmental pressure from measuring signals of the environmental pressure sensor (6).

5. A fill level measuring device (1) according to claim 1, wherein the container pressure sensor (5) is embodied water-tight and is connected to the processing unit (3) via an electrical line to transfer the measuring signals.

6. A fill level measuring device (1) according to claim 1, further comprising at least one pressure connector (7), which is in an effective connection to the container pressure sensor.

7. A fill level measuring device (1) according to claim 6, wherein the pressure connector (7) comprises a closure (10) for the container (11) and is embodied such that when the closure (10) is placed upon the container (11) one end of the pressure connector (7) ends in an area of a bottom of the container (11).

8. A fill level measuring device (1) according to claim 7, wherein the pressure connector (7) is provided with a stiff part (7b) and a flexible part (7a), with the stiff part (7b) of the pressure connector extending into the container when the closure is placed (10) onto the container (11), and the remaining part of the pressure connector (7) being embodied at least partially in a flexible manner.

9. A fill level measuring device (1) according to claim 8, further comprising a conveyor line (8) to transport the liquid foods out of the container (11) and the conveyor line (8) is at least partially arranged with a portion of the pressure connector (7) extending into the container (11).

10. A fill level measuring device according to claim 1, further comprising a conveyor line (8) for the liquid food and a temperature sensor (4), with the temperature sensor (4) being thermally connected to the conveyor line (8) such that the temperature of a liquid flowing in the conveyor line (8) can be measured via the temperature sensor (4).

11. A refrigeration device for liquid food, comprising an insulating vessel to receive a container (11) of liquid food, a refrigeration assembly for cooling the insulating vessel, and a fill level measuring device (1) for measuring the fill level of the liquid food in the container, the fill level measuring device (1) comprising a sensor unit (12) and a processing unit (3), with the processing unit (3) being connected to the sensor unit (2) and embodied such that the processing unit (3) determines the fill level of the liquid food in the container (11) depending on measuring signals from the sensor unit (2), the sensor unit (2) comprises a container pressure sensor (5) that can be brought into an effective connection with the liquid food in the container (11) to measure a fluid pressure of the liquid food in the container (11) and the processing unit (3) is embodied such that it determines the fill level of the liquid food in the container (11) depending on a difference of a measured fluid pressure in reference to environmental pressure.

12. A refrigeration device for liquid foods according to claim 11, wherein the fill level measuring device (1) is arranged in the insulating vessel.

13. A refrigeration device for liquid foods according to claim 12, wherein the insulating container is divided by a separating wall (12) into first and second chambers, with the first chamber being embodied to accept the container (11) for liquid food, and at least the processing unit (3) of the fill level measuring device (1) being arranged in the second chamber.

14. A method for measuring a fill level of liquid food in a container, comprising the following steps:
measuring a fluid pressure of the liquid food in a bottom area of the container,
measuring environmental pressure,
determining the fill level of the liquid food in the container depending on the fluid pressure and the environmental pressure.

15. A method according to claim 14, wherein the fluid pressure is determined at a vertical distance of maximally 5 cm from the bottom of the container.

16. A method according to claim 15, wherein, if the fill level is determined depending on a difference between the fluid pressure and the environmental pressure, the fill level of the liquid food in the container is determined.

17. A method according to claim 14, wherein the fluid pressure is determined at a vertical distance of maximally 1 cm from the bottom of the container.

18. A fill level measuring device (1) according to claim 1, wherein the fill level measuring device (1) is embodied such that the fluid pressure can be measured in an area of a bottom of the container (11) at a height of less than 1 cm above the bottom of the container.
